(19) United States
(12) Patent Application Publication
(10) Pub. No.: US 2024/0132164 A1
(43) Pub. Date: Apr. 25, 2024

(54) Adjustable Bedslide Deck

(71) Applicant: Leer Group, Elkhart, IN (US)

(72) Inventors: Eugene A. Dylewski, II, Granger, IN (US); Harley D. Harrison, South Bend, IN (US); Ian E. Dill, South Bend, IN (US); Tommy C. Brock, Nappannee, IN (US)

(21) Appl. No.: 18/381,286

(22) Filed: Oct. 17, 2023

Related U.S. Application Data
(60) Provisional application No. 63/380,289, filed on Oct. 20, 2022.

(51) Int. Cl. B62D 33/08

(52) U.S. Cl. CPC B62D 33/08

(57) ABSTRACT

An adjustable bedslide assembly is provided. The adjustable bedslide assembly sets onto a cargo box of a pickup truck and is extendable and retractable relative to the cargo box. The adjustable bedslide assembly includes a deck assembly and a frame assembly. The frame assembly is composed of a first frame section and a second frame section. The first frame section is configured to attach to the cargo box while the second frame section attaches to the deck assembly. The first deck portion is engageable with the second deck portion so the deck assembly is adjustably sizable to fit within the dimensions of the cargo box.

### RELATED APPLICATIONS

The present application relates to and claims priority to U.S. Provisional Patent Application, Ser. No. 63/380,289, filed on Oct. 20, 2022. The subject matter disclosed in that Provisional Application is hereby expressly incorporated into the present application.

### TECHNICAL FIELD AND SUMMARY

The present disclosure relates to trucks, such as pickup trucks, and truck beds or cargo boxes used on pickup trucks and like vehicles. In particular, the present disclosure relates to a bedslide assembly affixed to the cargo box and includes a deck that is adjustably-sized to fit into cargo boxes of different sizes.

A truck bed or cargo box is a large open space of a pickup truck located behind the cab section. The cargo box is typically composed of a floor bounded by opposing sidewalls. A bulkhead wall extends between the opposed sidewalls and is located adjacent the cab section. A tailgate is located opposite the bulkhead wall at the rear end of the cargo box and is movable between open and closed positions.

An issue with pickup truck cargo boxes is they may be of any variety of sizes based on the make, model, and year of the pickup truck. Some cargo boxes are large having a relatively large floor space, others relatively small, and a myriad of others in-between. For example, such cargo box sizes may include full, short, and extra short truck beds 65 to 82 inches, as well as compact truck beds 53 to 73 inches. Because cargo boxes come in different sizes, bedslides, likewise, come in different sizes to accommodate them. Additionally, because bedslides fitting into cargo boxes of about any size require relatively large shipping boxes, they are not suitable for common residential carrier delivery.

Accordingly, an illustrative embodiment of the present disclosure provides an adjustable bedslide assembly. The adjustable bedslide assembly sets onto a cargo box of a pickup truck and is extendable and retractable relative to the cargo box. The adjustable bedslide assembly includes a deck assembly and a frame assembly. The frame assembly is composed of a first frame section and a second frame section. The first frame section is configured to attach to the cargo box while the second frame section attaches to the deck assembly. The second frame section is engageable with and movable relative to the first frame section. The deck assembly is composed of a first deck portion and a second deck portion. The first deck portion includes a plurality of ribs being regularly spaced on the first deck portion. The second deck portion includes a plurality of ribs being regularly spaced on the second deck portion. The first deck portion overlaps the second deck portion so the deck assembly is adjustably sizable to fit within dimensions of the cargo box. At least one rib of the plurality of ribs of the first deck portion engages at least one rib of the plurality of ribs of the second deck portion.

In the above and other embodiments, the adjustable bedslide assembly further comprises: one or more fasteners attach the first deck portion and the second deck portion together; the first deck portion is movable with respect to the second deck portion to change a size of the deck assembly; the plurality of ribs of the first deck portion are regularly spaced apart from each other and the plurality of ribs of the second deck portion are regularly spaced apart from each other to allow the first deck portion to be moved to any of a plurality of predetermined positions with respect to the second deck portion; any at least one rib of the plurality of ribs of the first deck portion engages any at least one rib of the plurality of ribs of the second deck portion in order to change a size of the deck assembly from a first predetermined size to a second predetermined size; the deck assembly is selected from the group consisting of a platform and a tray; a partition that is sized to engage the at least one rib of the plurality of ribs of the first deck portion; the first deck portion is fully separable from the second deck portion; the second frame section is attachable to both the first deck portion and to the second deck portion.

Another illustrative embodiment of the present disclosure provides an adjustable bedslide assembly. The adjustable bedslide assembly sets onto a cargo box of a pickup truck and is extendable and retractable relative to the cargo box. The adjustable bedslide assembly includes a deck assembly and a frame assembly. The frame assembly is composed of a first frame section and a second frame section. The first frame section is configured to attach to the cargo box while the second frame section attaches to the deck assembly. The second frame section is engageable with and movable relative to the first frame section. The deck assembly is composed of a first deck portion and a second deck portion. The first deck portion includes at least one rib that extends along the first deck portion. The second deck portion includes at least one rib that extends along the second deck portion. The at least one rib of the first deck portion engages the at least one rib of the second deck portion so a size of the deck assembly is adjustable.

In the above and other embodiments, the adjustable bedslide assembly further comprises: the at least one rib of the first deck portion includes a plurality of holes each regularly spaced along the at least one rib of the first deck portion; the at least one rib of the second deck portion includes a plurality of holes each regularly spaced along the at least one rib of the second deck portion, at least one hole of the plurality of holes of the first deck portion is alignable with at least one hole of the plurality of holes of the second deck portion, and wherein a fastener is disposable through the at least one hole of the plurality of holes of both the first deck portion and the second deck portion to secure them together; first deck portion overlaps the second deck portion; the at least one rib of the first deck portion is a plurality of ribs; the first deck portion overlaps the second deck portion so the deck assembly is adjustably sizable to fit within dimensions of the cargo box; the deck assembly is selected from the group consisting of a platform and a tray; the first deck portion is fully separable from the second deck portion; and the second frame section is attachable to both the first deck portion and to the second deck portion.

Another illustrative embodiment of the present disclosure provides an adjustable bedslide assembly. The adjustable bedslide assembly sets onto a cargo box of a pickup truck and is extendable and retractable relative to the cargo box. The adjustable bedslide assembly includes a deck assembly and a frame assembly. The frame assembly is composed of a first frame section and a second frame section. The first frame section is configured to attach to the cargo box while the second frame section attaches to the deck assembly. The first deck portion is engageable with the second deck portion so the deck assembly is adjustably sizable to fit within dimensions of the cargo box.

In the above and other embodiments, the adjustable bedslide assembly further comprises the first deck portion with a first index, and the second deck portion with a second index so that the first deck portion is positionable to any one of a plurality of positions with respect to the second deck portion. This makes the deck assembly adjustably sizable to any one of a plurality of predetermined sizes based on the first and second indexes.

Additional features and advantages of the adjustable bedslide assembly will become apparent to those skilled in the art upon consideration of the following detailed descriptions of carrying out the adjustable bedslide assembly as presently perceived.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a side perspective partial cutaway view of a cargo box with an adjustable bedslide assembly recess therein;

FIG. 2 is a side perspective partial cutaway view of a cargo box with an adjustable bedslide assembly partially extended therefrom;

FIG. 3 is a side perspective partial cutaway view of a cargo box with an adjustable bedslide assembly further extended therefrom;

FIG. 4 is a side perspective partial cutaway view of a cargo box with an adjustable bedslide assembly fully extended therefrom;

FIG. 5 is a perspective view of an adjustable deck assembly portion of the adjustable bedslide assembly;

FIG. 6 is a perspective exploded view of an adjustable deck assembly portion of the adjustable bedslide assembly;

FIG. 7 is a perspective sectional detail sectional view of an adjustable deck assembly;

FIG. 8 is a perspective view of the adjustable deck assembly;

FIG. 9 is a perspective view of another illustrative embodiment of an adjustable deck assembly;

FIG. 10 is a top view of the adjustable deck assembly;

FIG. 11 is a side elevational view of the adjustable deck assembly;

FIG. 12 is another top view of the adjustable deck assembly;

FIG. 13 is another side elevational view of the adjustable deck assembly;

FIG. 14 is another top view of the adjustable deck assembly;

FIG. 15 is another side elevational view of the adjustable deck assembly;

FIG. 16 is another top view of the adjustable deck assembly;

FIG. 17 is another side elevational view of the adjustable deck assembly;

FIG. 18 is another top view of the adjustable deck assembly;

FIG. 19 is another side elevational view of the adjustable deck assembly;

FIG. 20 is another top view of the adjustable deck assembly;

FIG. 21 is another side elevational view of the adjustable deck assembly;

FIG. 22 is an underside view of an adjustable bedslide assembly;

FIG. 23 is an underside detail view of a portion of the adjustable bedslide assembly;

FIG. 24 is another underside detail view of a portion of the adjustable bedslide assembly;

FIG. 25 is another underside perspective view of the adjustable bedslide assembly;

FIG. 26 is another underside perspective view of the adjustable bedslide assembly with the deck assembly located in a partially extended position;

FIG. 27 is another underside perspective view of the adjustable bedslide assembly with the deck assembly located in a further extended position;

FIG. 28 is another underside perspective view of the adjustable bedslide assembly with the deck assembly located in a full extended position;

FIG. 29 is a perspective view of the lower frame assembly;

FIG. 30 is an exploded perspective view of the lower frame assembly;

FIG. 31 is a perspective view of the upper frame assembly;

FIG. 32 is an exploded perspective view of the upper frame assembly;

FIG. 33 is a perspective view of the side rail with the latch assembly attached thereto;

FIG. 34 is another perspective view of the side rail with the latch assembly attached thereto;

FIG. 35 is a perspective detail view of the side rail portion of the upper frame assembly;

FIG. 36 is another perspective detail view of the side rail portion of the upper frame assembly;

FIG. 37 is an underside detail view of a portion of the side rail;

FIG. 38 is an exploded detail view of the latch assembly of the upper frame assembly;

FIG. 39 is a detail exploded view of a portion of the side rail portion of the upper frame assembly;

FIG. 40 is an exploded view of the side rail of the upper frame assembly;

FIG. 41 is an exploded detail view of the side rail of the upper frame assembly;

FIG. 42 is an assembled detail view of a portion of the side rail of the upper frame assembly;

FIG. 43 is a perspective view of an deck assembly with partitions;

FIG. 44 is another perspective detail view of the deck assembly with partitions;

FIG. 45 is an exploded view of an unassembled adjustable bedslide assembly;

FIG. 46 is an exploded view of the adjustable bedslide assembly, identifying its constituent parts that fit into the box in an unassembled condition.

Corresponding reference characters indicate corresponding parts throughout the several views. The exemplification set out herein illustrates embodiments of the adjustable bedslide assembly, and such exemplification is not to be construed as limiting the scope of the adjustable bedslide assembly in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a bedslide assembly that sets onto a cargo box floor and is extendable and retractable relative thereto. The deck of the bedslide, however, is made of multiple components that are attachable in a way that can produce a relatively large bedslide deck or small bedslide deck. For example, the bedslide deck may be composed of a first deck portion and a second deck portion. The first deck portion may overlap the second deck portion and be attached thereto at any, or at a predetermined, position to create a complete deck sized for the particular cargo box size the bedslide is being installed on.

In a further embodiment, the deck portions may include a plurality of corresponding ribs or other like indexing and/or coupling structures at regular, or other predetermined, intervals. These ribs may engage each other to create a complete deck. The particular rib of a first deck portion will engage a particular rib on a second deck portion depending on the size of the cargo box floor. In this way, the complete deck can be made larger or smaller as needed.

Additionally, because the bedslide deck is typically the largest overall structure of a bedslide assembly, making the bedslide deck composed of multiple smaller deck portions means the overall size of a bedslide shipping box can now be smaller and, thus, more manageable for shipping. Since bedslides are often aftermarket accessories for pickup truck cargo boxes, they are purchased and assembled onto the cargo box by a third party. With a smaller shipping box, this adjustably-sized bedslide can be shipped using a common carrier to a customer, distributor, or retailer less expensively.

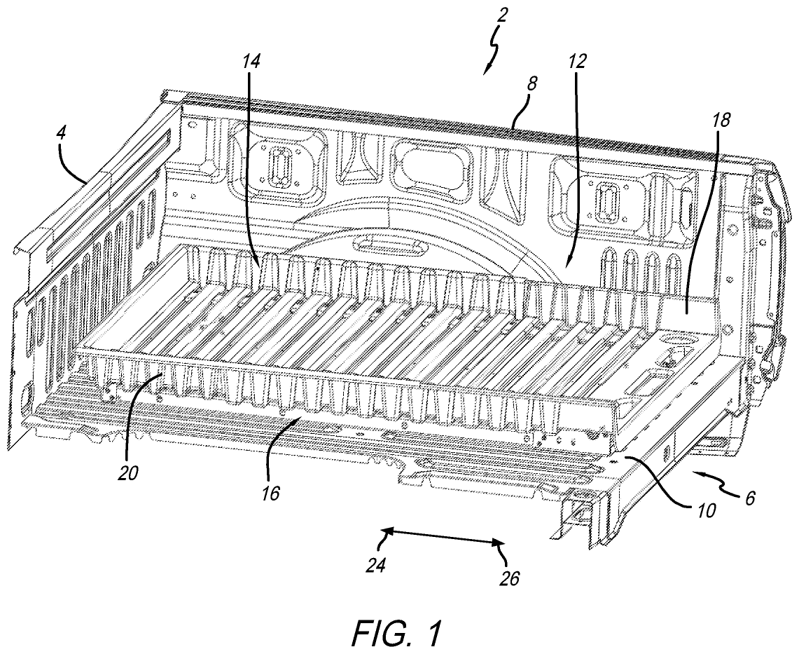

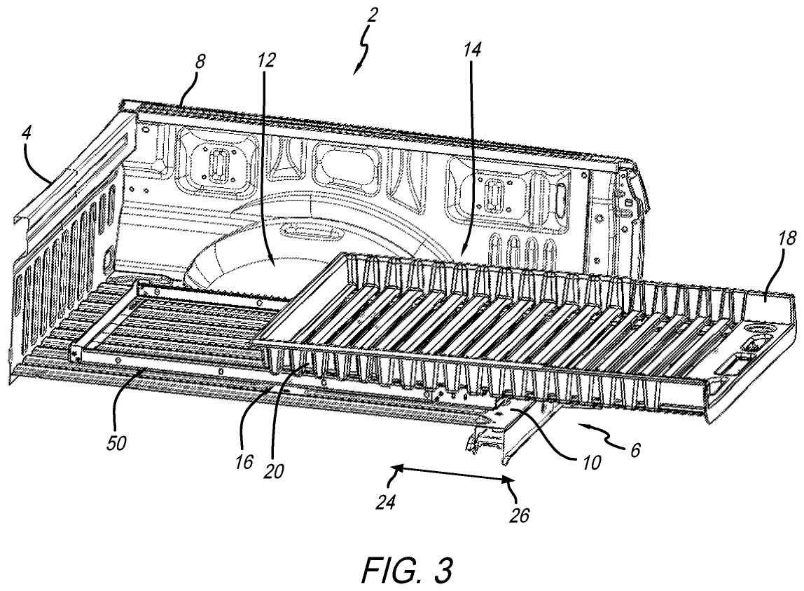

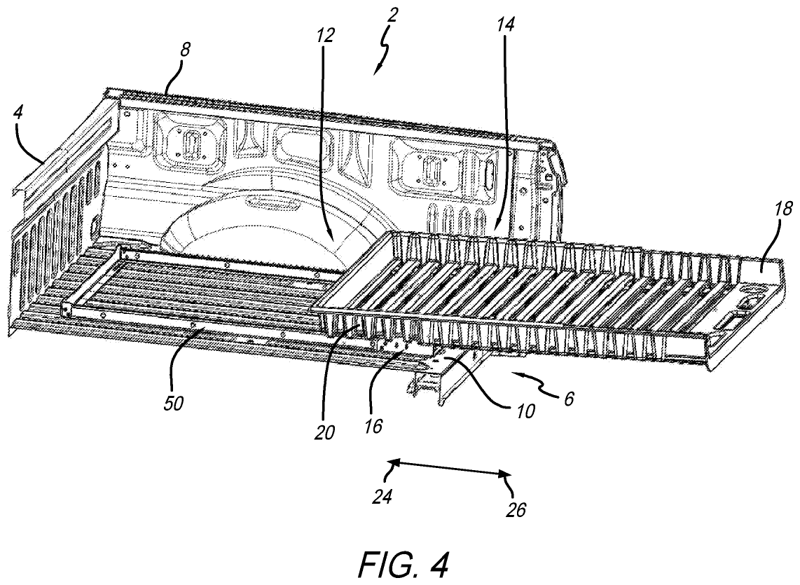

Perspective views of a cargo box 2 are shown in FIGS. 1 through 4. The cargo box 2 includes a bulkhead 4, tailgate 6, and opposing sidewalls 8. One of the sidewalls 8 (as well as the tailgate) is removed to better view cargo box floor 10 as shown. Attached to cargo box floor 10 is an adjustable bedslide assembly 12. This adjustable bedslide assembly 12 includes the adjustable deck assembly 14 seated on a frame assembly 16. The latter of which is attached to floor 10 of cargo box 2. Adjustable deck assembly 14 itself includes a first deck portion 18 and a second deck portion 20 that are coupled together to fit within cargo box 2. Illustratively, adjustable deck assembly 14 is shown in the form of a tray. It is appreciated that the configuration of adjustable deck assembly 14 may be a pan, flat deck, or other suitable support platform that can be moved along the frame assembly 16 to comprise the adjustable bedslide assembly 12.

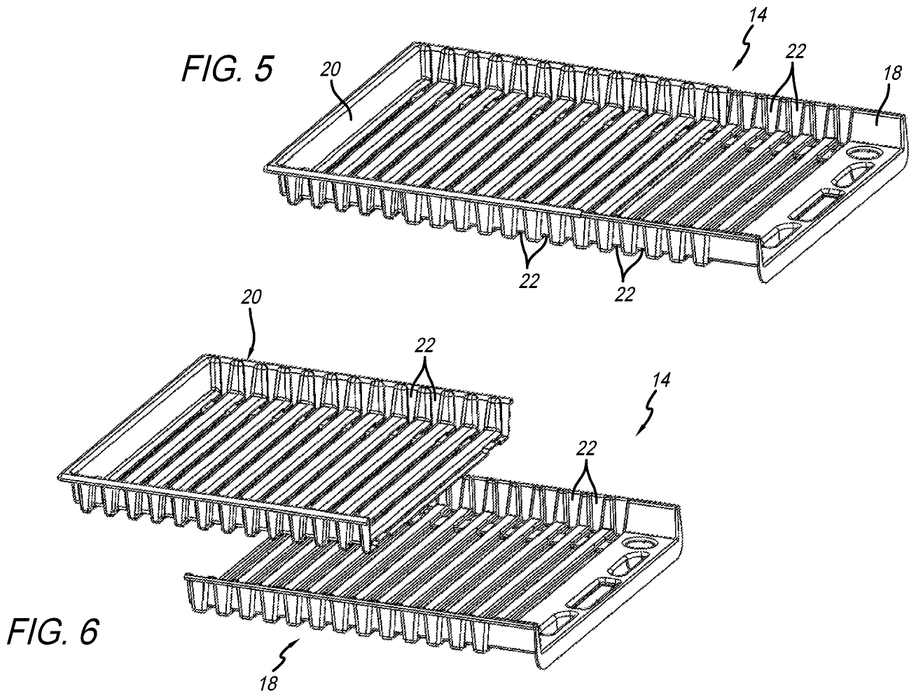

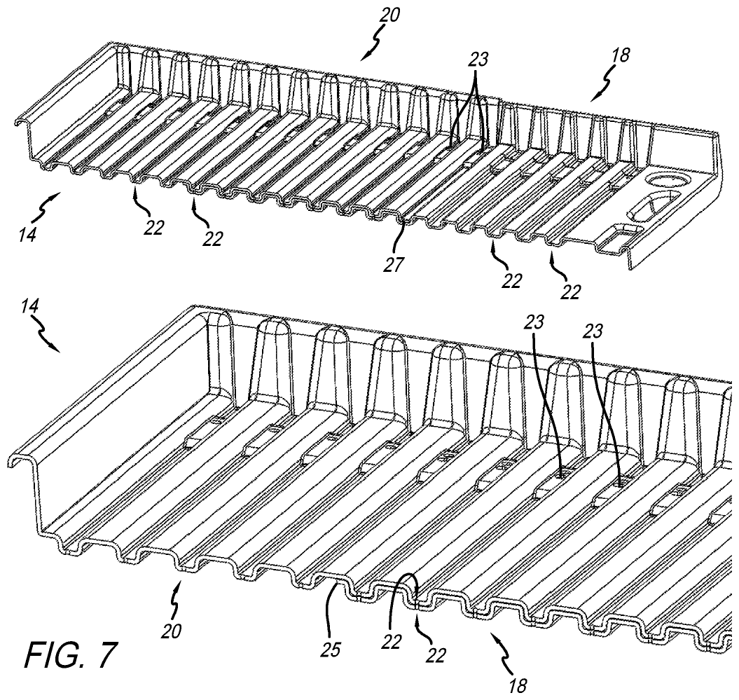

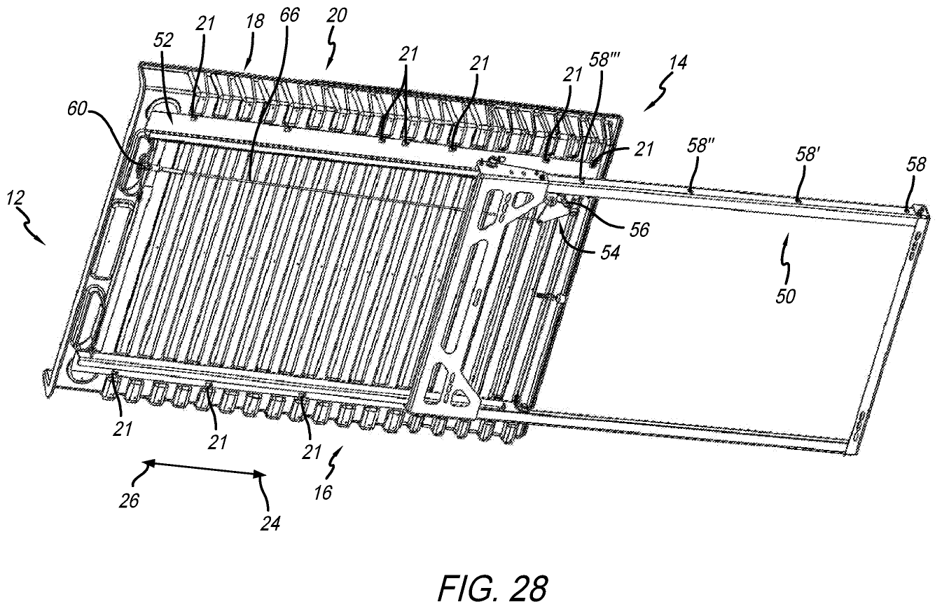

Further, in this illustrative embodiment, the first and second deck portions 18 and 20, respectively, may include corresponding indexing ribs 22 (see FIGS. 5 and 6), or other indexing structures that can be used to help position deck portions 18 and 20 with respect to each other as needed to fit within the particularly sized cargo box 2. Once deck portions 18 and 20 are so positioned relative to each other, they can be secured to frame assembly 16 and/or each other, to fix the size of adjustable deck assembly 14. It is appreciated that such securement between first deck portion 18 and second deck portion 20 may be permanent or temporary, depending on the desired use of adjustable bedslide assembly 12. In an illustrative embodiment, one or more fasteners 21 (see, e.g., FIG. 28) may be used to extend, through both first deck portion 18 and second deck portion 20, apertures 23 (see, e.g., FIG. 7) to attach both together. In embodiments, other fasteners, or even the design of the deck portions themselves may be such that they can be fixed together and/or be securable and releasable.

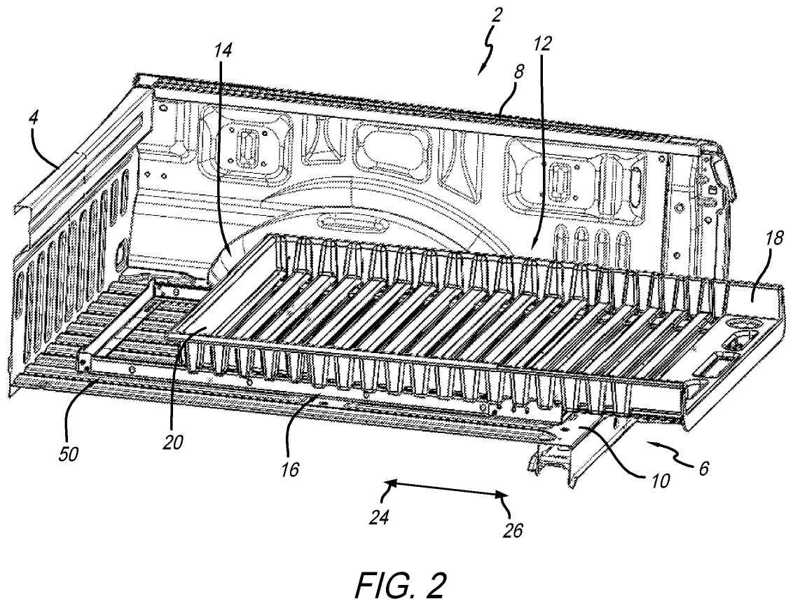

Once adjustable deck assembly 14 is sized as needed for the particular size of cargo box 2, frame assembly 16 may move adjustable deck assembly 14 back and forth as indicated by the directional arrows 24 and 26 to move same like a conventional bedslide. This is apparent by virtue of the views shown in FIGS. 2, 3, and 4 depicting adjustable deck assembly 14 extending outward in direction 26 from tailgate end of cargo box 2 in different amounts like bedslides are known to do. Here, however, adjustable deck assembly 14 has been sized for the particular illustrative cargo box 2 shown.

It will be appreciated by the skilled artisan upon reading this disclosure that if the cargo box shown is larger, adjustable deck assembly 14 may likewise be made larger by moving the first and second deck portions 18 and 20 relative to each other to create a larger footprint. Conversely, if the cargo box is smaller than that shown, the deck portions 18 and 20 may be adjusted so that it has a smaller footprint to fit within that smaller cargo box. The net result is that this same adjustable bedslide assembly 12 can be used with any cargo box having any variety of size. This eliminates the necessity of having to build bedslide assemblies of multiple sizes. This, in turn, no longer requires wholesalers and/or retailers to stock bedslide assemblies of multiple sizes to accommodate all the different sized cargo boxes of all the different pickup trucks in existence. This single adjustable bedslide assembly may be used to accommodate many, if not most, or possibly all, cargo box sizes of the different popular pickup truck makes, models, and years. It is further appreciated that the structures so identified in FIG. 1 are also in FIGS. 2, 3, and 4, as well.

The perspective views of adjustable deck assembly 14 is shown in FIGS. 5, 6, 7, and 8. Illustratively, adjustable deck assembly 14 includes the first deck portion 18 and the second deck portion 20. The perspective view shown in FIG. 5 illustrates how the first and second deck portions 18 and 20 are seated onto each other. The perspective exploded view of adjustable deck assembly 14 shows first deck portion 18 and second deck portion 20 separated to demonstrate the two components of adjustable deck assembly 14. It is appreciated that although the illustrated embodiment includes first and second deck portions 18 and 20, adjustable deck 14 assembly may be composed of multiple deck portions that are more than two. Additionally, the configuration of adjustable deck assembly 14 being a tray as shown, is also illustrative. Adjustable deck assembly 14 may alternatively be a flat deck, pan, or other like configuration. The deck portions may have upturned sides, rails, or no lateral containment features.

Adjustable deck assembly 14 may also include multiple indexing ribs 22, as shown, spaced apart to make sizing and coupling deck portions 18 and 20 together to create an appropriately sized deck. Such indexing ribs 22 may be regularly spaced apart as shown to make the sizing process convenient. Indexing ribs 22 may also, illustratively, be spaced apart any desired distance. In an illustrative embodiment, such spacing may be 1 to 3 inches, for example. It is known that several popularly sized cargo boxes have a different size that varies by just a few inches. Some General Motors' cargo boxes extend five feet eight inches, whereas Ford has cargo boxes five feet five inches, and Toyota may have a cargo box just under five feet, five inches. Thus, in some instances, having the ability to make small adjustments to the overall size of the adjustable deck assembly can be useful.

A perspective sectional and detail sectional view of adjustable deck assembly 14 is shown in FIG. 7. The view in the top image shows both first deck portion 18 and second deck portion 20, wherein second deck portion 20 overlaps a portion of first deck portion 18. The series of indexing ribs 22 on both first deck portion 18 and second deck portion 20 are complementarily shaped, as shown, so they nest within each other regardless to the extent, in this case, second deck portion 20 overlaps first deck portion 18. It is appreciated that any one of indexing ribs 22 of second deck portion 20 can fit with any of indexing ribs 22 of first deck portion 18. End 25 of first deck portion 18 and end 27 of second deck portion 20 are shown in these views. By moving second deck portion 20 away from first deck portion 18 so that fewer indexing ribs 22 overlap, adjustable deck assembly 14 can be made larger. Conversely, when placing more of second deck portion 20 on first deck portion 18 of adjustable deck assembly 14 is made smaller. Thus, trial and error can be employed moving the two deck portions further away or toward each other until the desired size of adjustable deck assembly 14 is attained based on the needs and/or size of cargo box 2.

Once the desired size of adjustable deck assembly 14 is attained, one or more fasteners 21 (see FIG. 28) can be secured through one or more overlapping indexing ribs 22 through apertures 23 (see FIG. 7) of same on first and second deck portions 18 and 20 to secure the two together. It is appreciated that in other embodiments, other fastening-type means may be employed. Also alternatively, indexing ribs 22 may be configured in other ways to interlock the two deck portions together, either permanently or releasably. The latter of which allows the size of adjustable deck assembly 14 to be selectively easily changed as desired. In the illustrated embodiment, apertures 23 are disposed through the indexing ribs 22 of both first deck portion 18 and second deck portion 20 and aligned to allow fastener 21 to extend through both and secure the deck portions together.

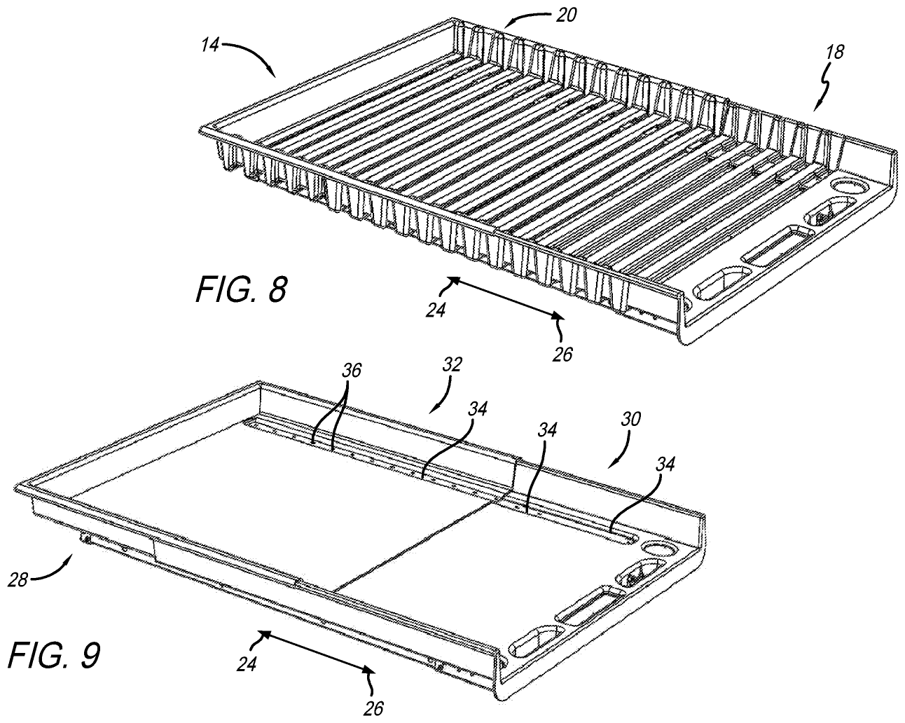

The perspective view of the adjustable deck assembly 14 shown in FIG. 8 demonstrates how first deck portion 18 and second deck portion 20 overlap each other based on indexing ribs 22 to create an adjustable deck assembly 14 of desired size. This view further demonstrates that by moving second deck portion 20 according to directional arrows 24 or 26, it can either increase or decrease the overall size of adjustable deck assembly 14 by increasing or decreasing the overlap of second deck portion 20 with respect to first deck portion 18.

A perspective view of another illustrative embodiment of an adjustable deck assembly 28 is shown in FIG. 9. Again, it is appreciated that other indexing configurations may be employed to move and secure second deck portion 32 with respect to first deck portion 30. In this illustrative embodiment, linearly aligned indexing ribs 34 are extended from front to rear of first deck portion 30 and second deck portion 32. These indexing ribs 34 may be employed instead of the multiple laterally aligned indexing ribs 22, like that shown in FIG. 8. Apertures 36 in indexing ribs 34 of adjustable deck assembly 28, shown in FIG. 9, may be regularly spaced to allow first deck portion 30 to be secured to second deck portion 32, via fasteners that can extend through aligned apertures 36, when the desired size of adjustable deck assembly 28 is reached. It is further appreciated that other indexing and securement means may be employed, which allows deck portions 30 and 32 to be positioned at any of a variety of positions with respect to each other and then secured to achieve the desired deck size. For example, a channel may be attached to a second deck portion with a T-nut attached to side rails of the upper frame assembly to provide any number of adjustment positions.

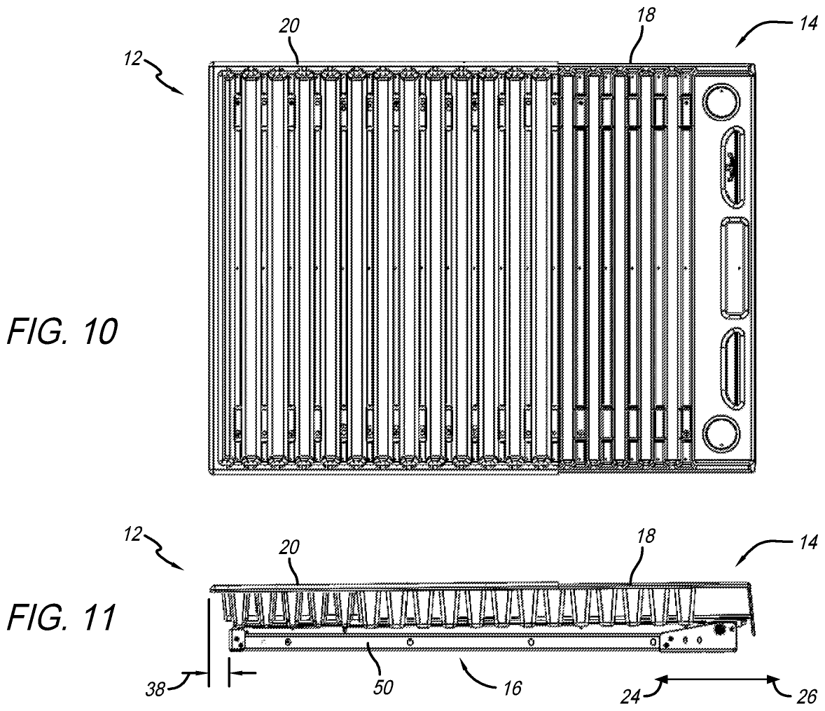

A series of top and side progression views demonstrating how adjustable deck assembly 14 can adjust its size as shown in FIGS. 10, 11, 12, 13, 14, 15, 16, 17, 18, 19, 20, and 21. The top and side view, shown in FIGS. 10 and 11, respectively, depicts second deck portion 20 moved back along first deck portion 18 about six indexing ribs 22 counting from the front of first deck portion 18 back. This results in a relatively short adjustable deck assembly 14 that illustratively does not extend much further than the rear of the upper frame assembly 16, as shown in the side view of FIG. 11. This is depicted, as shown, by dimensional arrows 38.

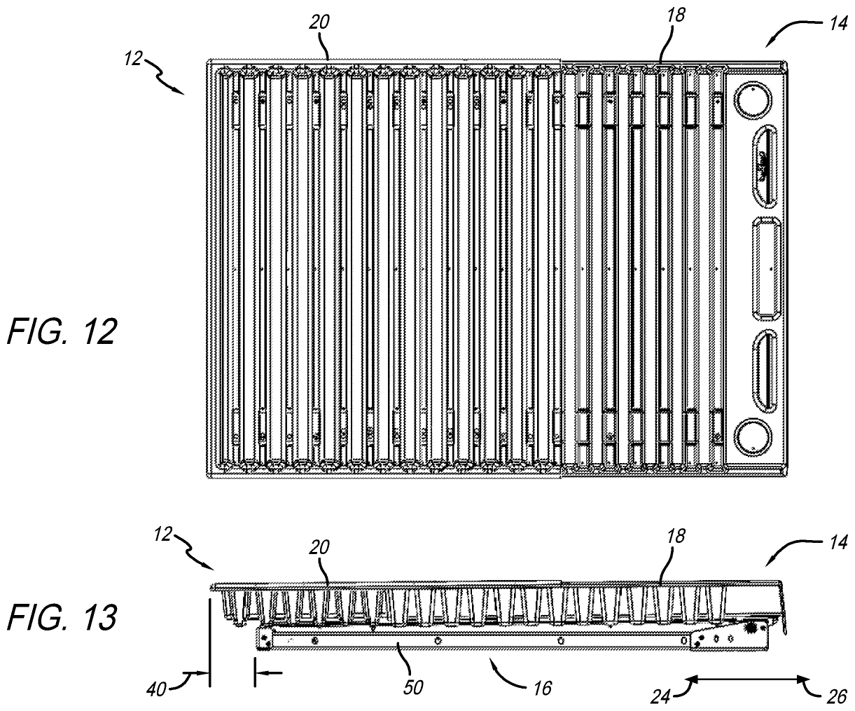

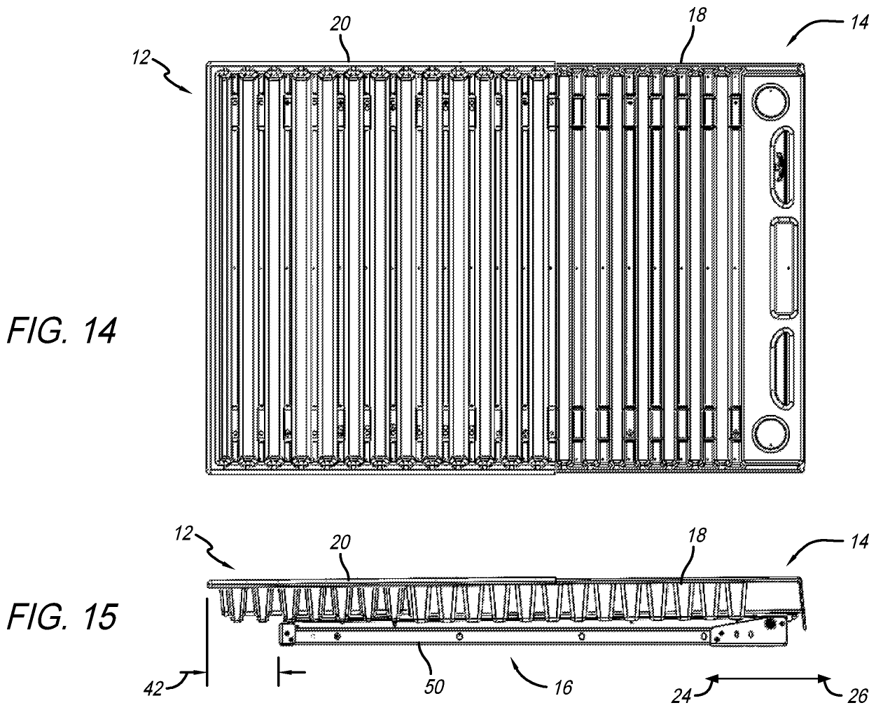

The views shown in FIGS. 12 and 13, depict second deck portion 20 moved further back on first deck portion 18, in this case about seven indexing ribs 22. This produces a longer adjustable deck assembly 14 as indicated by dimensional arrows 40, shown in FIG. 13. Moving the second deck portion 20 further back in direction 24, as demonstrated in FIGS. 14 and 15, in this case, about eight indexing ribs, further increases the size of the adjustable deck assembly 14. This increase is depicted by the dimensional arrows 42 shown in FIG. 15. It is appreciated that, comparing these dimensional arrows 42 in FIG. 15 with dimensional arrows 40 from FIG. 13 and dimensional arrows 38 from FIG. 11, demonstrate how the size of adjustable deck assembly 14 can be increased.

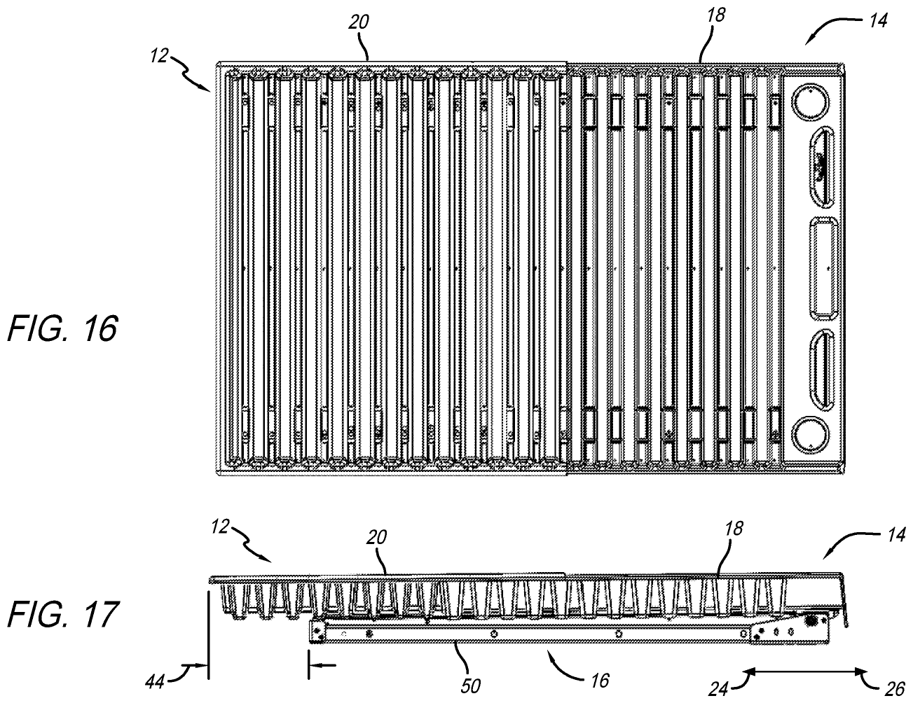

In similar fashion, as shown in FIGS. 16 and 17, moving second deck portion 20 further rearward in direction 24 with respect to the first deck portion 18, in this case, about nine indexing ribs 22, makes adjustable deck assembly 14 even larger. This is appreciated by the dimensional arrows 44, as shown in FIG. 17. The result is that adjustable deck assembly 14 is larger in size than that shown in FIG. 11, 13, or 15.

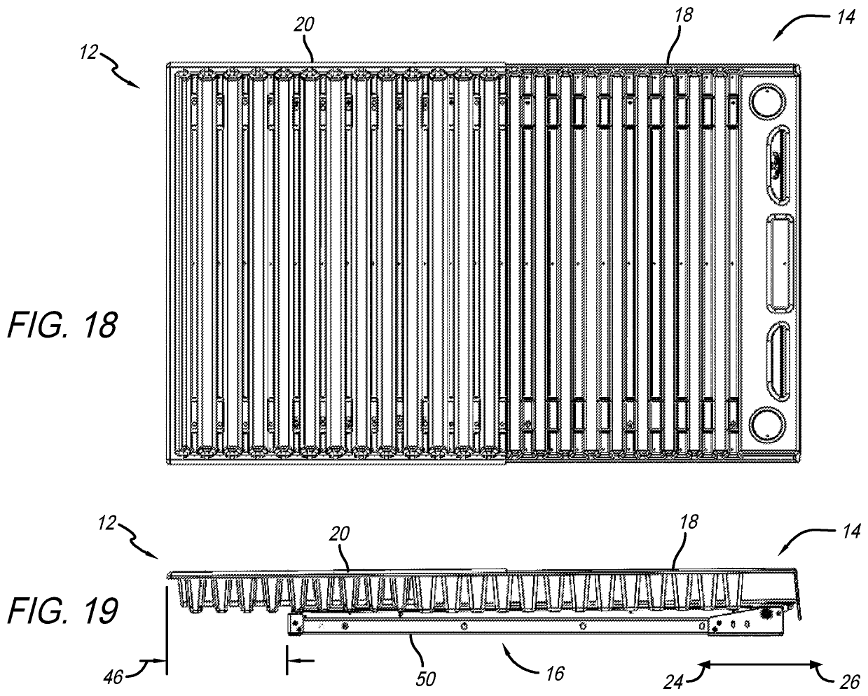

The top and side views of adjustable deck assembly 14, shown in FIGS. 18 and 19, respectively, depict adjustable deck assembly 14 expanded to an even larger size. Here, second deck portion 20 has been moved back with respect to first deck portion 18 about 10 indexing ribs 22 to increase the size of the adjustable deck assembly. This increase in size is evident by virtue of the dimensional arrows 46, shown in FIG. 19, when compared to dimensional arrows 38, 40, 42, and 44, shown in FIGS. 11, 13, 15, and 17. It is appreciated that the size of frame assembly 16 is such that it can be accommodated in the floors of cargo boxes of any variety of sizes. It is adjustable deck assembly 14 that increases or decreases in size to maximize same within the particular dimensions of any variety of cargo boxes.

The size of the cargo box that can accommodate an adjustable deck assembly 14, of the size as shown in FIGS. 18 and 19, is larger than the cargo box size that accommodates adjustable deck assembly 14, sized as shown in FIGS. 10 and 11, for example.

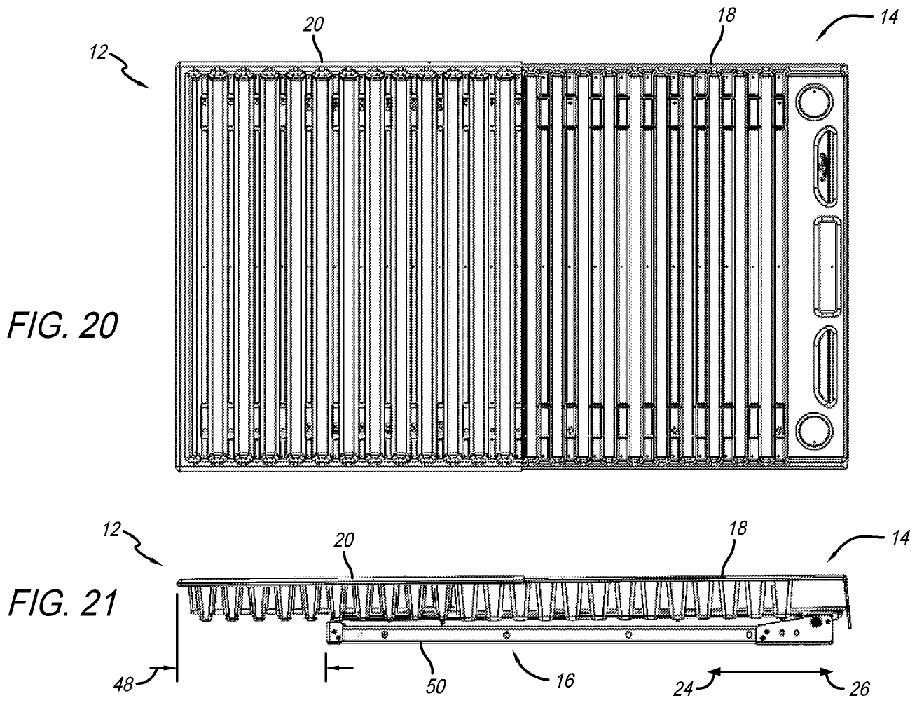

The top and side views of adjustable deck assembly 14, shown in FIGS. 20 and 21, demonstrate a yet increased size of adjustable deck assembly 14. Second deck portion 20 is moved rearward with respect to first deck portion 18 in direction 24 about eleven indexing ribs 22. In this case, there is less overlap between first deck portion 18 and second deck portion 20 as compared to the size of adjustable deck assembly 14 shown in FIGS. 10 and 11, for example. First deck portion 18 and second deck portion 20 can be fastened or otherwise attached together with the rear portion of second deck assembly 20 extending further rearward from frame assembly 16 than that shown in the previous examples and as indicated by dimensional arrows 48.

In sum, the views of FIGS. 10 through 21 demonstrate how adjustable deck assembly 14 can be adjusted to create larger or smaller deck footprints. It is appreciated that this is achieved without the need for multiple, differently sized, bedslide assemblies. This single adjustable bedslide assembly 12 may, thus, fit within cargo box 2 of any variety of different sizes.

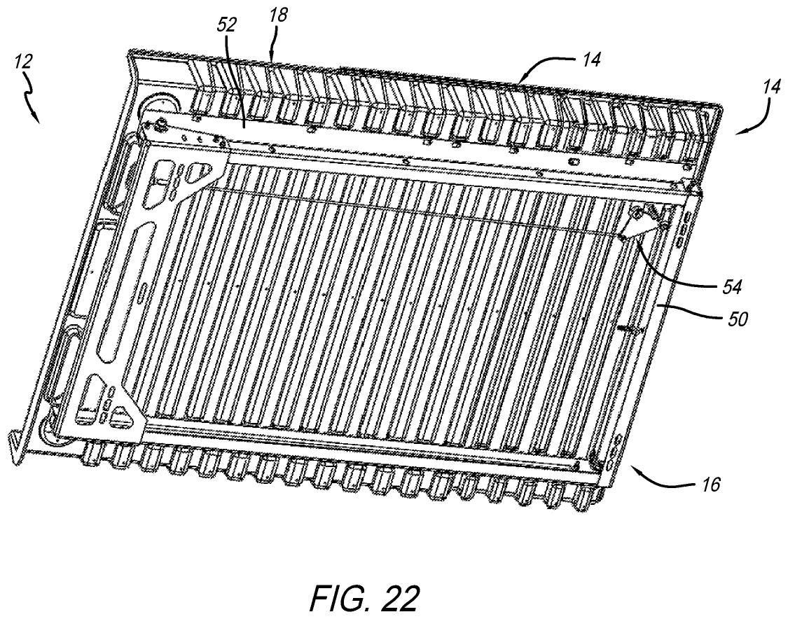

An underside view of adjustable bedslide assembly 12 is shown in FIG. 22. This view shows the frame assembly 16 attached to the underside of the adjustable deck assembly 14. Frame assembly 16 is illustratively composed of a lower frame assembly 50 and an upper frame assembly 52. Upper frame assembly 52 is attached to adjustable deck assembly 14, whereas lower frame assembly 50 is attached to floor 10 of the cargo box 2 (see, also, FIGS. 1-4). A latch assembly 54 is attached to upper frame assembly 52 and interacts with lower frame assembly 50 to limit movement between these frame assemblies.

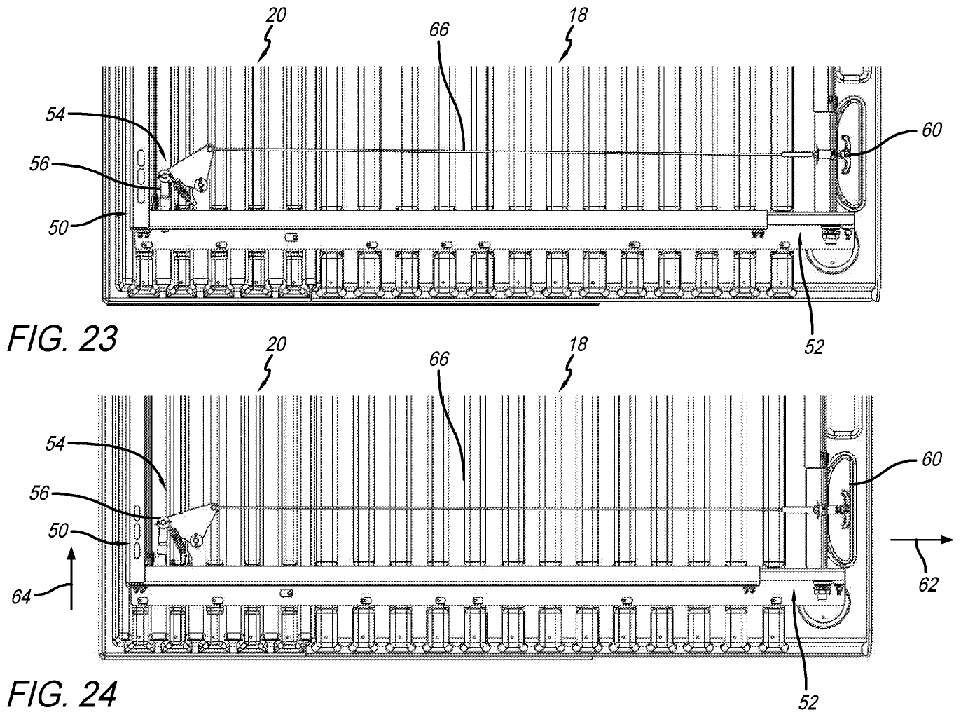

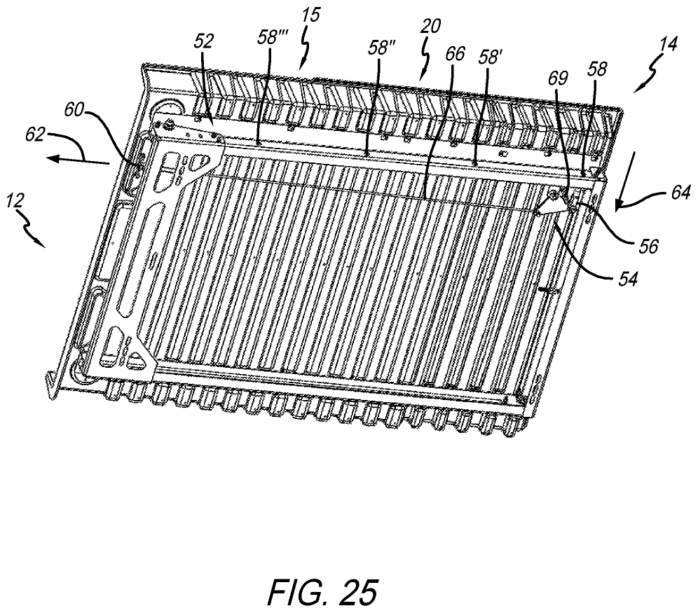

Underside views of adjustable bedslide assembly 12 are shown in FIGS. 23 and 24. These views depict latch assembly 54 engaging and disengaging from lower frame assembly 50. The view shown in FIG. 23 includes latch 56 of latch assembly 54 engaged with lower frame assembly 50. Illustratively, a series of holes or openings 58 in lower frame assembly 50 receive latch 56 (see, also, FIGS. 25-28). This prevents movement of upper frame assembly 52 (and, thus, adjustable deck assembly 14), with respect to lower frame assembly 50. The view in FIG. 24 shows that when a handle 60 on latch assembly 54 is pulled, latch assembly 54 removes latch 56 from opening 58 in the lower frame assembly 50 allowing movement of upper frame assembly 52 (and, thus, adjustable deck assembly 14) with respect to lower frame assembly 50. This is indicated by directional arrows 62 and 64, respectively, shown herein. A cable or wire 66 is attached to both handle 60 and latch assembly 54 to release latch 56, as illustratively shown. It is appreciated that latch assembly 54 is spring-loaded via spring 69 so that when handle 60 is released, latch 56 will bias towards lower frame assembly 50 and is available to engage an opening 58, therein, to secure upper frame assembly 52 in a static position.

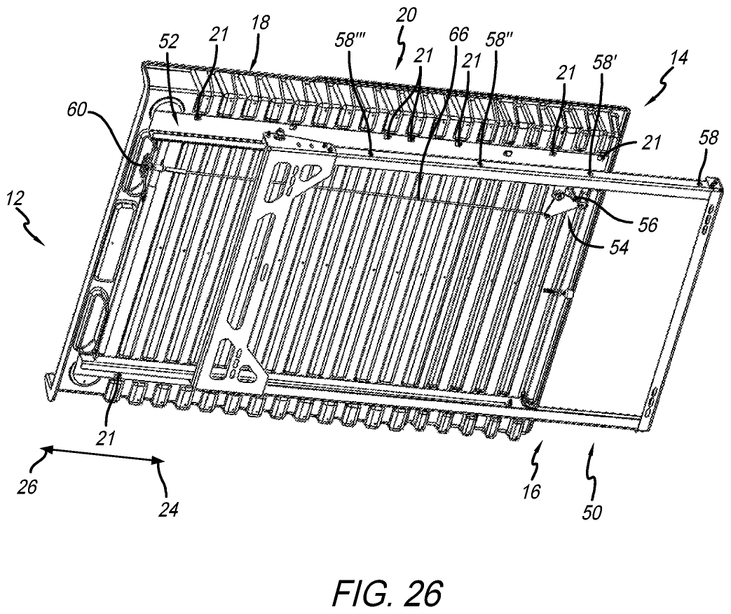

Underside perspective views of adjustable bedslide assembly 12 are shown in FIGS. 25, 26, 27, and 28. These views demonstrate how adjustable deck assembly 14 is movable with respect to frame assembly 16, and in particular, lower frame assembly 50. As shown in FIG. 25, adjustable deck assembly 14 is located in its fully retracted position. Here, latch 56 of the latch assembly is positioned in the first stop opening 58 of lower frame assembly 50. To move adjustable bedslide assembly 12, handle 60 is pulled, as indicated by directional arrow 62 which removes latch 56 from the first stop opening 58, also, as indicated by directional arrow 64. This allows upper frame assembly 52, with adjustable deck assembly 14 attached thereto, to move outwardly according to directional arrow 26 shown in FIG. 26. If handle 60 is released, latch 56 biases towards lower frame assembly 50 and will enter a second stop opening 58′ when adjustable deck assembly 14 is moved further outwardly.

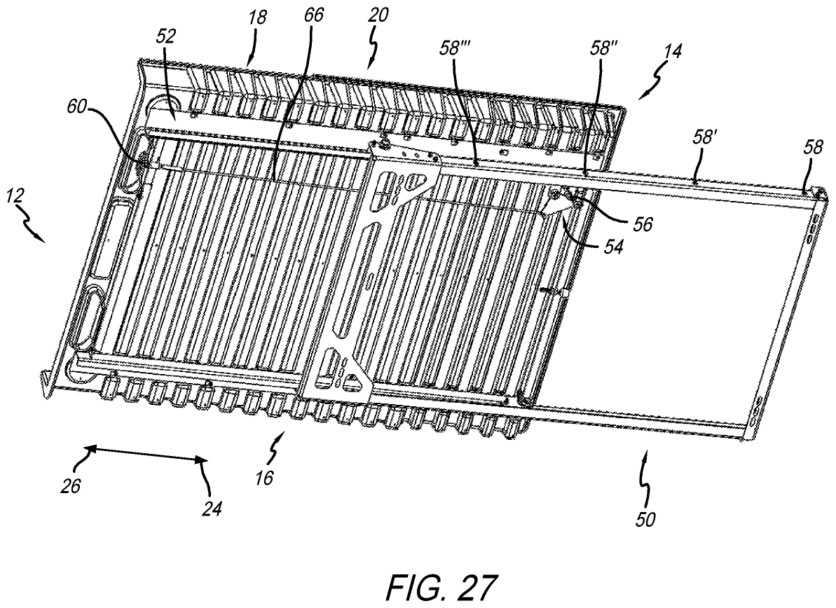

As shown in FIG. 26, latch 56 is located in second stop opening 58′ which holds adjustable deck assembly 14 in that position until latch 56 is affirmatively removed. As shown in FIG. 27, adjustable deck assembly 14 and upper frame assembly 52 move outwardly according to directional arrow 26 along lower frame assembly 50 until latch 56 engages third stop opening 58″. At this point, adjustable deck assembly 14 is held in that position until removed. In similar fashion, and as shown in FIG. 28, further movement of adjustable deck assembly 14 outward, as indicated by directional arrow 26, moves adjustable deck assembly 14 until latch 56 engages fourth stop opening 58′″. Adjustable deck assembly 14 is held in this extended position until latch 56 is removed. At which point, adjustable deck assembly 14 may be slid back in direction 24 to its stowed position or pulled further forward to be removed.

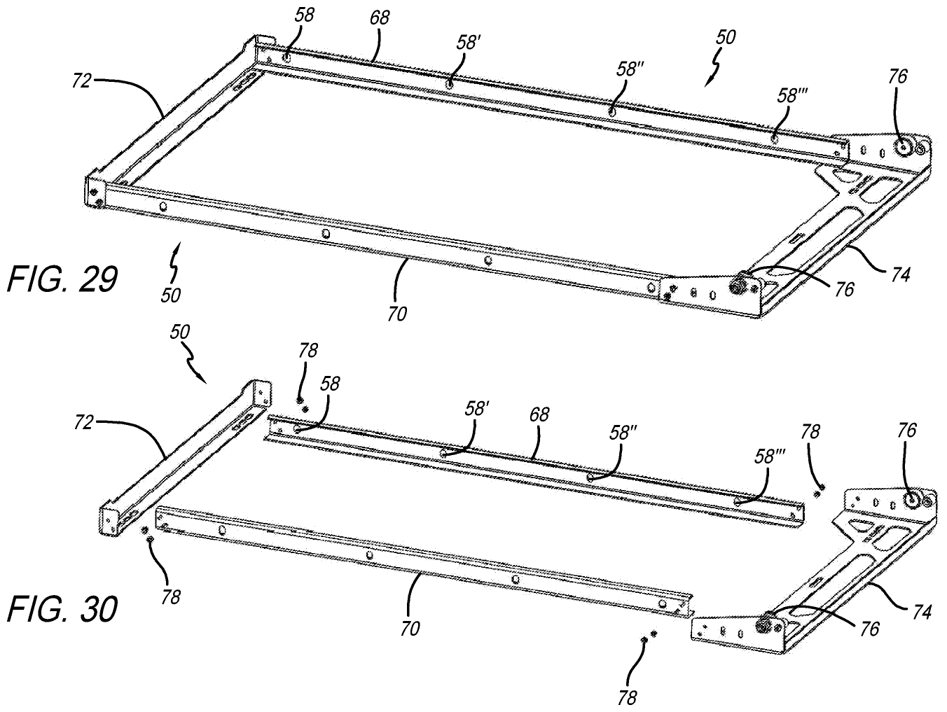

A perspective view of lower frame assembly 50 is shown in FIG. 29. Shown are side tracks 68 and 70, respectively, each with first, second, third, and fourth stop openings 58, 58′, 58,″ 58′″, respectively, and spaced apart by connecting rear bracket 72 and front bracket 74. Illustrative rollers 76 are shown on each side of front bracket 74. It is contemplated that lower frame assembly 50 is attached to floor 10 of cargo box 2. In other embodiments, lower frame assembly 50 may be adapted with bracket members to alternatively attach to tie-down points already existing or formed on cargo box 2.

An exploded perspective view of lower frame assembly 50 is shown in FIG. 30. It is contemplated that side tracks 68 and 70 may be attached to rear bracket 72 and front bracket 74 via fasteners 78 as shown. Because lower frame assembly 50 is assemblable, it can be shipped disassembled in a box having a smaller footprint than would be required if lower frame assembly 50 was shipped fully assembled.

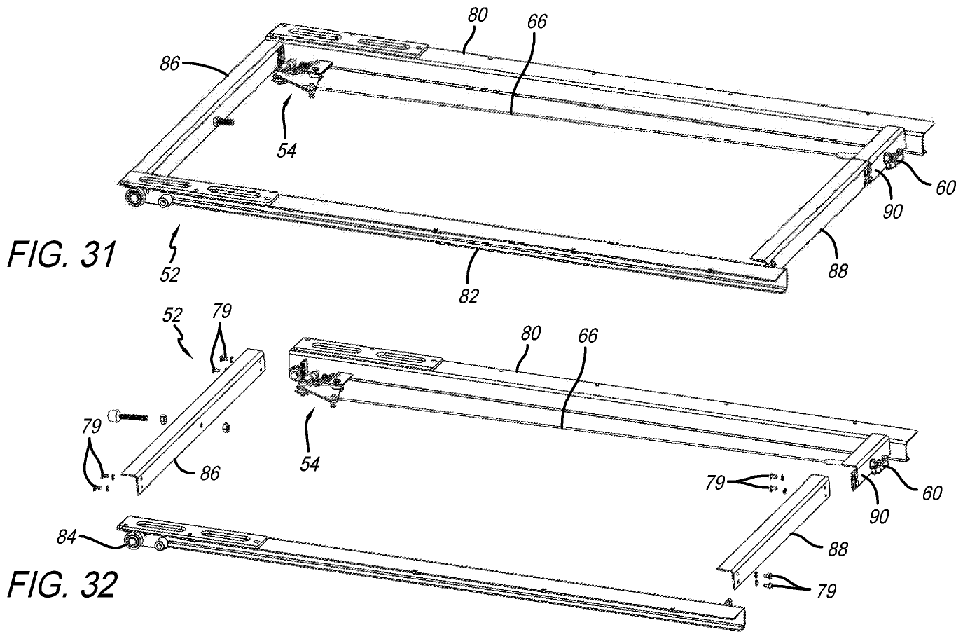

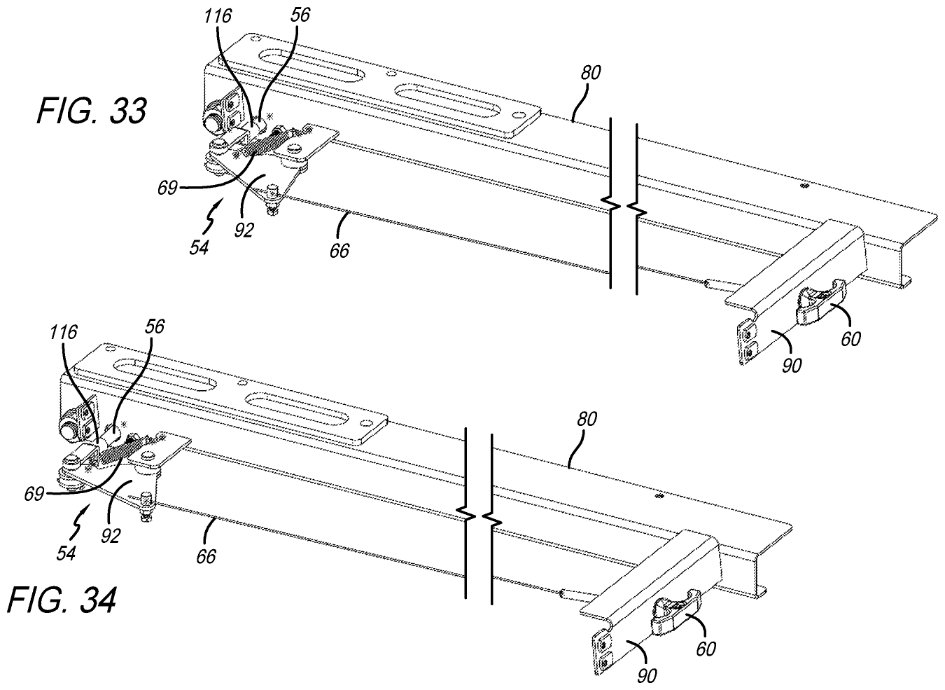

A perspective view of upper frame assembly 52 is shown in FIG. 31. Here, side rails 80 and 82, respectively, extend longitudinally to run alongside tracks 68 and 70, respectively, of lower frame assembly 50. Side rails 80 and 82 are attachable, illustratively, to underside of adjustable deck assembly 14. Rollers 84 are positioned on side rails 80 and 82 to assist in movement of upper frame assembly 52 with respect to lower frame assembly 50. Aperture 116 through side rail 80 (see FIGS. 33 and 34) allows latch 56 of the latch assembly 54 to be disposed therethrough and be selectively disposed through stop openings 58, 58′, 58″, 58′″, of side track 68. Cable 66 extends from latch assembly 54 to handle 60 located on front bracket 88. Handle 60 actuates latch assembly 54 to remove latch 56 from lower side track 68 and allow upper frame assembly 52 to move with respect to lower frame assembly 50.

An exploded perspective view of upper frame assembly 52 is shown in FIG. 32. In this view, side rails 80 and 82 are shown separated from rear bracket 86 and front bracket 88. Like lower frame assembly 50, upper frame assembly 52 is an assemblable component of adjustable bedslide assembly 12 so that it can be packaged in a box with a smaller footprint than a conventional bedslide. Here, rear bracket 86 is attachable to the rear of slide rails 80 and 82 via fasteners 79 to form the assembled structure shown in FIG. 31. Front bracket 88 is similarly attachable adjacent the front of side rail 82, via fasteners 79, as well. In an illustrative embodiment, a fixed portion 90 of front bracket 88 is fixedly attached to side rail 80 as shown in order to receive cable 66 and handle 60. This allows latch assembly 54 to be shipped in an assembled condition while still allowing the remaining upper frame assembly 52 to be shipped in a disassembled condition. As shown, front bracket 88 is fastened to fixed portion 90, as well as the opposing side rail 82.

Perspective views of side rail 80, with latch assembly 56 attached thereto are shown in FIGS. 33 and 34. The view in FIG. 33 depicts latch assembly 56 located in its latched position. Here, spring 69 maintains latch 56 in its latched condition unless handle 60 is pulled, which pulls on cable 66, which, in-turn, pulls latch assembly 54. This is what is shown in FIG. 34. When this happens, cable 66 pulls on and, thus, pivots latch plate 92 opposite the bias of spring 69, which pulls latch 56 out and away from side rail 80 of lower frame assembly 50. When this happens, upper frame assembly 52 (along with adjustable deck assembly 14 attached thereto) is movable alongside tracks 68 and 70 of lower frame assembly 50. This view also demonstrates how fixed portion 90 is attached to side rail 80 so that latch assembly 54, cable 66, and handle 60, can be shipped in an assembled condition, while the remainder of upper frame assembly 52 is disassembled for shipment.

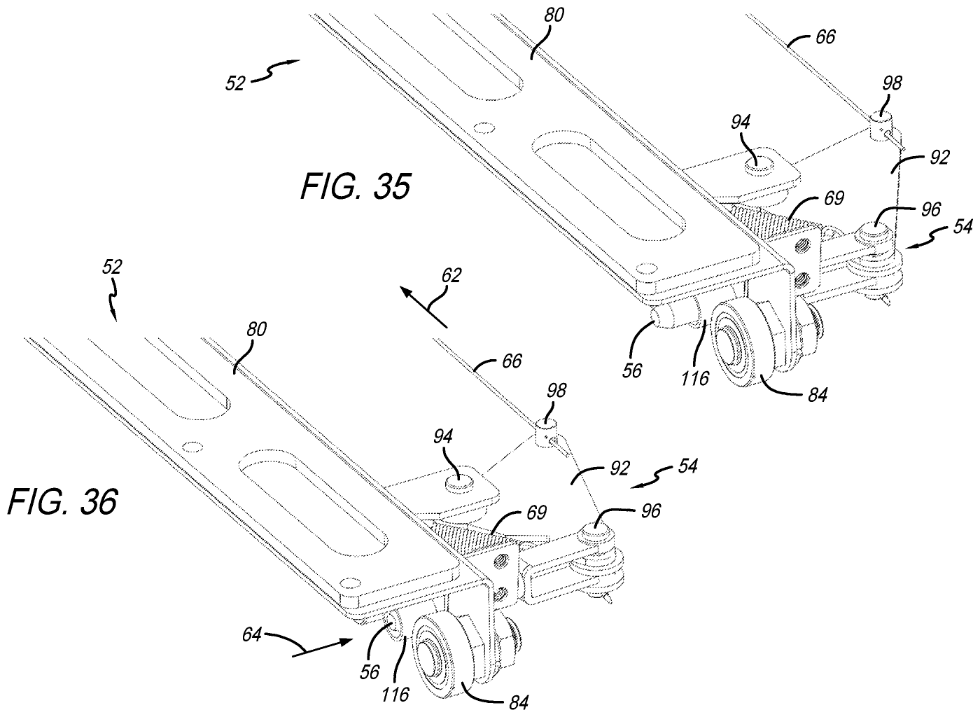

Perspective detail views of the side rail portion of upper frame assembly 52, that include latch assembly 54, are shown and FIGS. 35 and 36. The view in FIG. 35, like FIG. 33, depicts latch assembly 54 in its resting state where bias from spring 69 keeps latch 56 extended through side rail 80, which will also extend through one of the stop apertures in side track 68 of lower frame assembly 50. When cable 66 is pulled, as indicated by directional arrow 62 in FIG. 36, latch 92 pivots about a pivot pin 94 against the spring bias to retract latch 56 which itself is pivotally attached via a pin 96 on pivoting latch plate 92. It is appreciated that, for ease of construction, cable 66 can be extended through a tie pin 98 attached to pivoting latch plate 92, thereby securing cable 66 to latch plate 92. It is further appreciated that cable 66 may be a rod, ribbon, or other like longitudinally extending structure, to connect handle 60 to latch plate 92. As shown by directional arrow 64 in FIG. 36, latch 56 is retracted as a result of pulling on cable 66. Also shown in this view is roller 84 to assist in relative movement between upper frame assembly 52 and lower frame assembly 50.

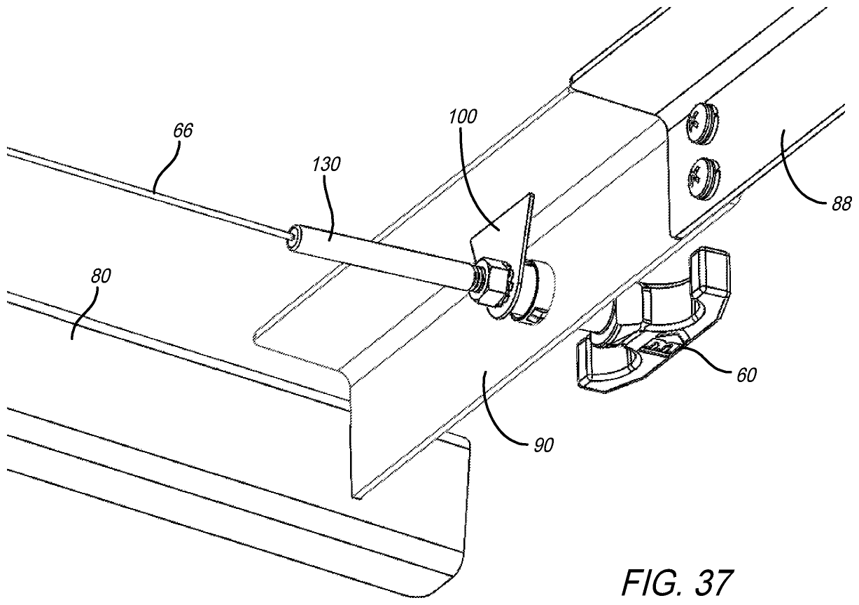

An underside detail view of a portion of side rail 80 is shown in FIG. 37. Here, cable 66 is shown extending through fixed portion 90 of upper frame assembly 52 and coupled to handle 60. Brace 100 is shown attached to the underside of fixed portion 90 to assist supporting cable 66 as it is disposed there through. Also shown, in this view, is front bracket 88 that is fastened to the fixed portion 90 to create the full extending front bracket assembly.

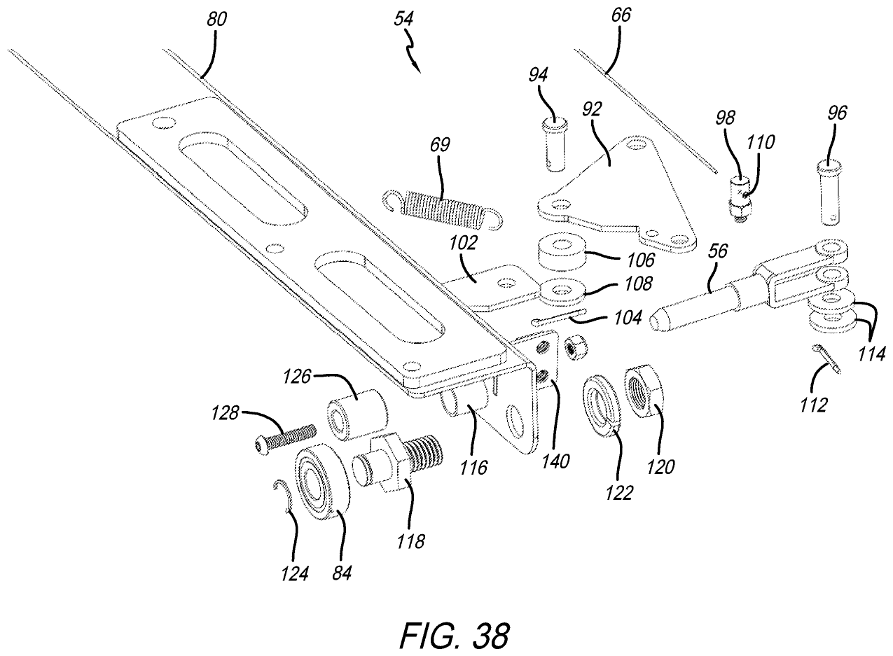

An exploded view of latch assembly 54 is shown in FIG. 38. This view shows pivoting latch plate 92 coupled to pivot base 102, via pivot pin 94 secured thereto, via a cotter split pin 104, with bushings 106 and/or washers 108 located on each side of pivot base 102, to assist in allowing the pivoting movement of pivoting latch plate 92 with respect to pivot base 102. Cable 66 is coupled to pivoting latch plate 92 via tie pin 98. Cable 66 extends through an opening 110 in tie pin 98 and secured therein to keep cable 66 taught between pivoting latch plate 92 and handle 60. Latch 56 is itself pivotally attached to pivoting latch plate 92, via a pin 96, and secured thereto via a cotter split pin 112, supporting washers 114 on pin 96. Pivoting latch plate 92 is what moves latch 56 within latch opening 116 of side rail 80 when cable 66 is pulled. Spring 69 is attached to both side rail 80 and latch 56 to bias towards latch opening 116. Thus, when cable 66 is not being pulled, latch 56 will be biased towards latch opening 116 and the latching condition.

Also shown, in this view, is roller 84 that is fitted on lower axle fastener 118, which extends through side rail 80 and is secured thereto via an illustrative nut 120 and washer 122. An illustrative C-clip 124 secures onto lower axle fastener 118 to hold roller 84 thereto. Also shown is a bushing 126 that is attached to side rail 80 via fastener 128. Bushing 126 helps guide side rail 80 in side track 68. This minimizes bearing side contact with side track 68, as well as side to side play with upper deck frame assembly 52 and lower frame assembly 50.

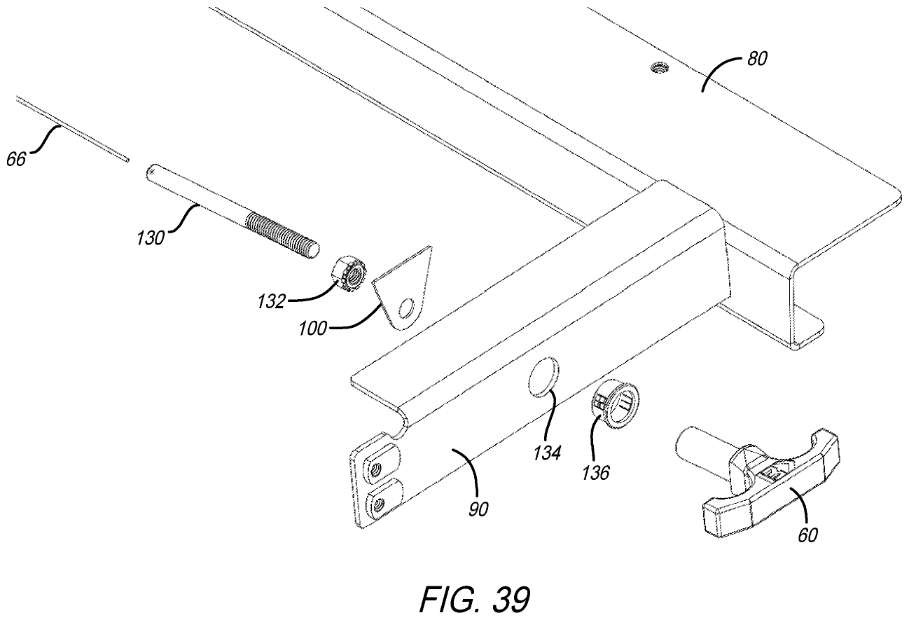

A detail exploded view of a portion of side rail 80 is shown in FIG. 39. In this view, cable 66, handle 60, and related components are shown in exploded view. Cable 66 is fitted into and secured within a swage fitting 130 that is illustratively threaded at one end. A nut 132 fits onto the threaded portion of the swage fitting 138, which is also extended through hole 134 in fixed portion 90 (see, also, FIG. 37). A collar 136 also fits into hole 134 in fixed portion 90, which also receives handle 60. With this configuration, handle 60 does not have as much tendency to rotate. Swage fitting 130 is attached to handle 60 so that, when pulled, it pulls cable 66 against the bias of spring 69 of latch assembly 54 (see, also, FIGS. 31, 32, 33, and 34), to release latch 56 from one of the stop openings in lower frame assembly 50 so adjustable deck assembly 14 and upper frame assembly 52, together, can move with respect to lower frame assembly 50 attached to cargo box floor 10. When handle 60 is released, the bias on latch 56 will be directed towards lower frame assembly 50 so that when a stop opening (either 58, 58′, 58″, 58′″) is encountered, latch 56 will insert itself into it.

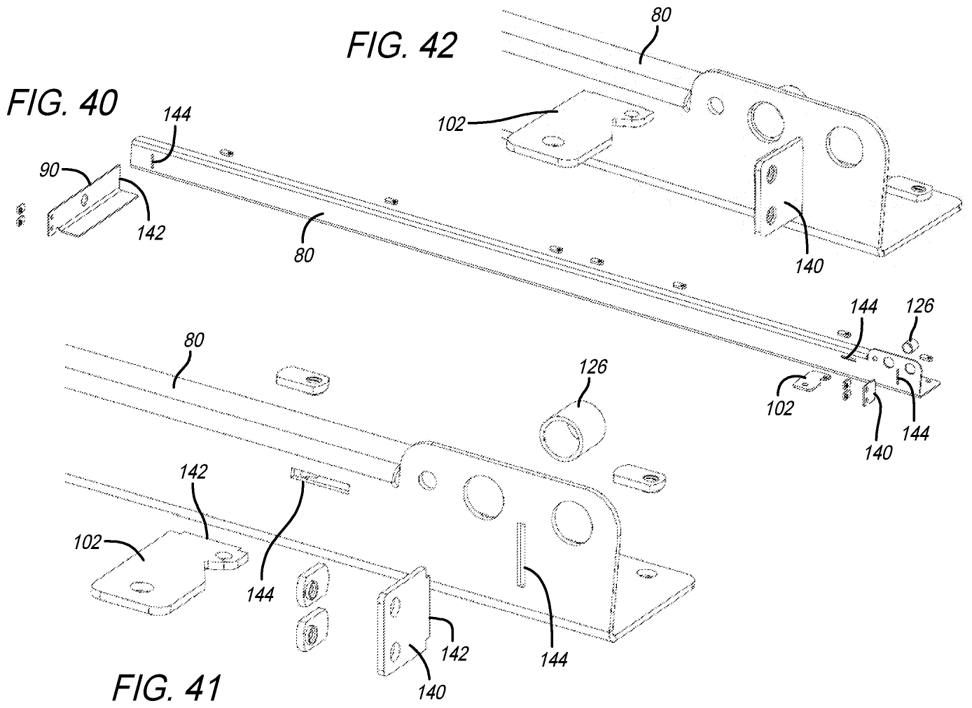

An exploded view, of side rail 80 of upper frame assembly 52, is shown in FIG. 40, while an exploded detail view of same is shown in FIG. 41, and an assembled detail view shown in FIG. 42. In this embodiment, pivot base 102, attachment bracket 140, and fixed portion 90 may be attached to side rail 80 by employing a tab 142 in slot 144 arrangement. The attaching components may include a tab 142 that fits into a slot 144 formed in side rail 80 and affixed thereto, via welding, adhesive, or other method. In other embodiments, the one or more of these components may be formed with the side rail extrusion and then folded or otherwise formed into the necessary bracket shape. The view in FIG. 41 shows pivot base 102 and attachment bracket 140 in exploded view configured to be inserted in corresponding slots 144 and attached thereto, as shown in FIG. 42.

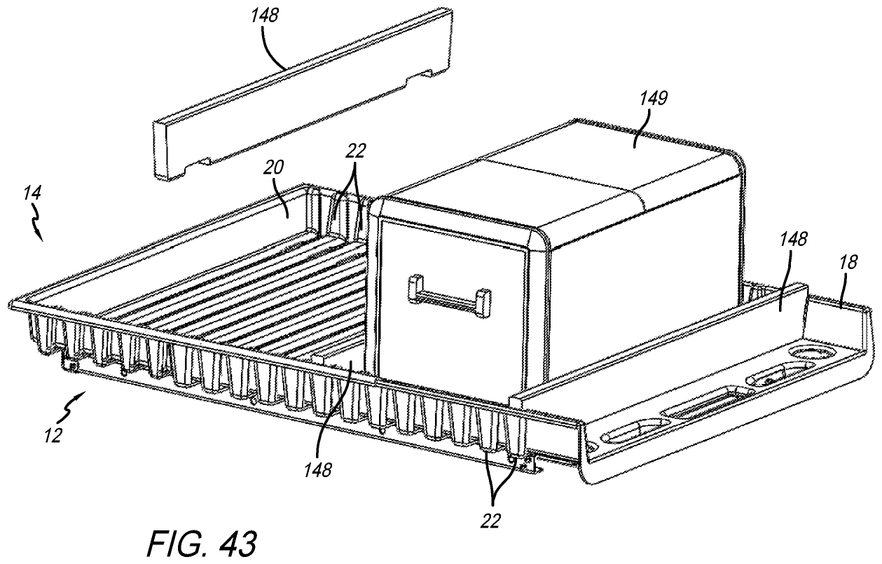

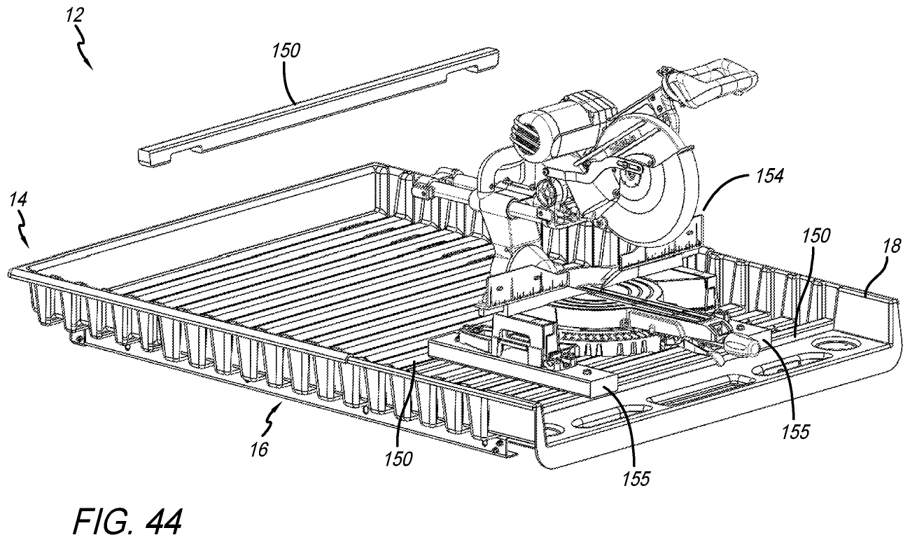

A perspective view of adjustable deck assembly 14 is shown in FIG. 43. In another illustrative embodiment, partitions 148 may be employed to segregate sections of adjustable deck assembly 14 to hold containers of other articles to a particular portion of the adjustable deck assembly. As shown, partitions 148 may illustratively be fitted into indexing ribs 22 on adjustable deck assembly 14, which can hold, as illustratively shown, a container 149 within this designated position in adjustable deck assembly 14. It is appreciated that these partitions 148 are illustrative only, and can be configured in other ways as desired. For example, and as shown in the perspective view of adjustable deck assembly 14 in FIG. 44, partitions 148 are replaced with tie down bars 150. In this case, tie down bars 150 can be used to support and secure an illustrative miter saw 154 on supports 155 of adjustable deck assembly 14. It is appreciated from these views how the partitions 148 or tie down bars 150 may be employed to customize the functionality of adjustable deck assembly 14, as desired. It is further appreciated that other such securement structures may be employed on adjustable deck assembly 14 to increase its functionality.

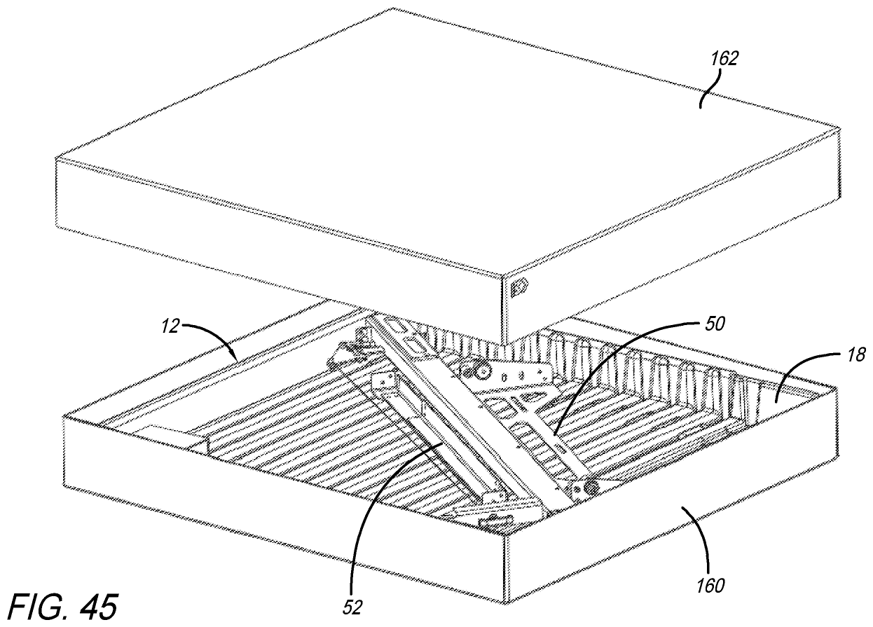

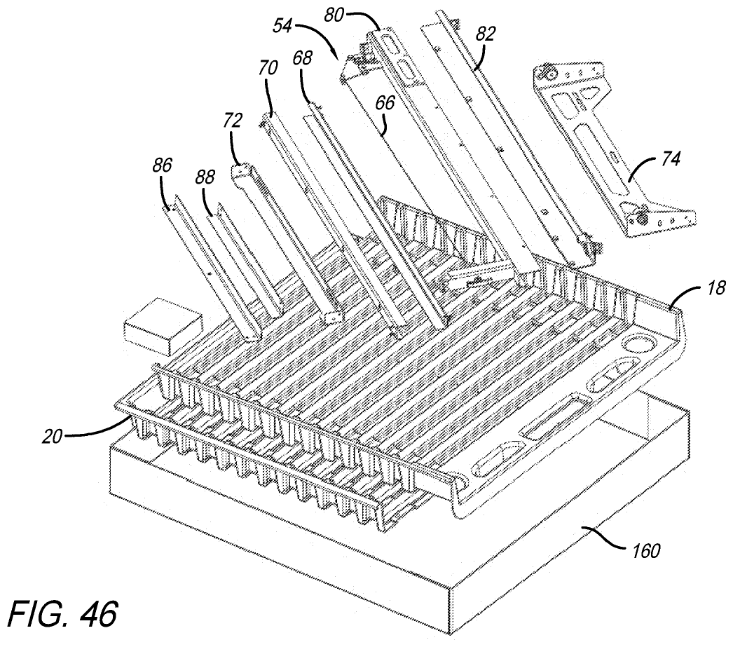

As previously stated, a feature of adjustable bedslide assembly 12 is that its unassembled footprint is smaller than that of a conventional bedslide assembly. This is in addition to adjustable bedslide assembly 12 being sizable to fit cargo box floors of any variety of sizes. Having a smaller, disassembled footprint, however, allows adjustable bedslide assembly 12 to be packaged and shipped in a box that is shippable via a common carrier. In an illustrative example, the perspective view shown in FIG. 45 depicts a disassembled adjustable bedslide assembly 12 fitted within a lower box 160 portion with an upper box portion 162 separated for demonstrable purposes. Upper box portion 162 fits over lower box portion 160 to form the full box. It is contemplated that this box is sized smaller than conventional bedslide assemblies and can be shipped via common carriers. For example, some common carriers have a maximum size combination for small package services. This is calculated by measuring the length and girth which must be less than a certain threshold. The formula is believed to be length plus 2× width plus 2× height. So, for example, and for demonstrative purposes, if a maximum size combination must be within 165 inches, the packaging shown in FIG. 45 may have a length of about 52 inches, width of about 49 inches, and a height of about 7 inches. Applying the maximum size combination formula, it comes to 164 inches. This means the adjustable bedslide assembly 12 can be shipped to distributors, retailers, and customers, using common carrier small package services, which reduces the shipping costs. Thus, adjustable bedslide assembly 12 serves both to reduce the number of SKUs required to provide a bedslide assembly that retailers and distributors must stock to accommodate the wide variety of cargo box sizes while allowing the adjustable bedslide assembly to be shipped in a more cost-efficient manner. Both can translate into reducing costs and increasing convenience for the distributor, retailer, and customer.

An exploded view of and unassembled adjustable bedslide assembly 12 before fitted into its lower box portion is shown in FIG. 45. This view further demonstrates how disassembled components, as previously discussed herein, assist in added functionality and utility by fitting into a smaller box footprint and, thus, being shippable via common carrier.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, then the disclosure from this non-provisional patent application controls.

What is claimed:

1. An adjustable bedslide assembly that sets onto a cargo box of a pickup truck and is extendable and retractable relative to the cargo box, the adjustable bedslide assembly comprising:
a deck assembly; and
a frame assembly;
wherein the frame assembly is composed of a first frame section and a second frame section;
wherein the first frame section is configured to attach to the cargo box;
wherein the second frame section attaches to the deck assembly;
wherein the second frame section is engageable with and movable relative to the first frame section;
wherein the deck assembly is composed of a first deck portion and a second deck portion;
wherein the first deck portion includes a plurality of ribs;
wherein each rib of the plurality of ribs of the first deck portion being regularly spaced on the first deck portion;
wherein the second deck portion includes a plurality of ribs;
wherein each rib of the plurality of ribs of the second deck portion being regularly spaced on the second deck portion;
wherein the first deck portion overlaps the second deck portion so the deck assembly is adjustably sizable to fit within dimensions of the cargo box; and
wherein at least one rib of the plurality of ribs of the first deck portion engages at least one rib of the plurality of ribs of the second deck portion.

2. The adjustable bedslide assembly of claim 1, wherein one or more fasteners attach the first deck portion and the second deck portion together.

3. The adjustable bedslide assembly of claim 1, wherein the first deck portion is movable with respect to the second deck portion to change a size of the deck assembly.

4. The adjustable bedslide assembly of claim 1, wherein the plurality of ribs of the first deck portion are regularly spaced apart from each other and the plurality of ribs of the second deck portion are regularly spaced apart from each other to allow the first deck portion to be moved to any of a plurality of predetermined positions with respect to the second deck portion.

5. The adjustable bedslide assembly of claim 4, wherein any at least one rib of the plurality of ribs of the first deck portion engages any at least one rib of the plurality of ribs of the second deck portion in order to change a size of the deck assembly from a first predetermined size to a second predetermined size.

6. The adjustable bedslide assembly of claim 1, wherein the deck assembly is selected from the group consisting of a platform and a tray.

7. The adjustable bedslide assembly of claim 1, further comprising a partition that is sized to engage the at least one rib of the plurality of ribs of the first deck portion.

8. The adjustable bedslide assembly of claim 1, wherein the first deck portion is fully separable from the second deck portion.

9. The adjustable bedslide assembly of claim 1, wherein the second frame section is attachable to both the first deck portion and to the second deck portion.

10. An adjustable bedslide assembly that sets onto a cargo box of a pickup truck and is extendable and retractable relative to the cargo box, the adjustable bedslide assembly comprising:
a deck assembly; and
a frame assembly;
wherein the frame assembly is composed of a first frame section and a second frame section;
wherein the first frame section is configured to attach to the cargo box;
wherein the second frame section attaches to the deck assembly;
wherein the second frame section is engageable with and movable relative to the first frame section;
wherein the deck assembly is composed of a first deck portion and a second deck portion;
wherein the first deck portion includes at least one rib;
wherein the at least one rib of the first deck portion extends along the first deck portion;
wherein the second deck portion includes at least one rib;
wherein the at least one rib of the second deck portion extends along the second deck portion; and
wherein the at least one rib of the first deck portion engages the at least one rib of the second deck portion so a size of the deck assembly is adjustable.

11. The adjustable bedslide assembly of claim 10, wherein the at least one rib of the first deck portion includes a plurality of holes each regularly spaced along the at least one rib of the first deck portion.

12. The adjustable bedslide assembly of claim 11, wherein the at least one rib of the second deck portion includes a plurality of holes each regularly spaced along the at least one rib of the second deck portion, at least one hole of the plurality of holes of the first deck portion is alignable with at least one hole of the plurality of holes of the second deck portion, and wherein a fastener is disposable through the at least one hole of the plurality of holes of both the first deck portion and the second deck portion to secure them together.

13. The adjustable bedslide assembly of claim 12, wherein the first deck portion overlaps the second deck portion.

14. The adjustable bedslide assembly of claim 10, wherein the at least one rib of the first deck portion is a plurality of ribs.

15. The adjustable bedslide assembly of claim 10, wherein the first deck portion overlaps the second deck portion so the deck assembly is adjustably sizable to fit within dimensions of the cargo box.

16. The adjustable bedslide assembly of claim 10, wherein the deck assembly is selected from the group consisting of a platform and a tray.

17. The adjustable bedslide assembly of claim 10, wherein the first deck portion is fully separable from the second deck portion.

18. The adjustable bedslide assembly of claim 10, wherein the second frame section is attachable to both the first deck portion and to the second deck portion.

19. An adjustable bedslide assembly that sets onto a cargo box of a pickup truck and is extendable and retractable relative to the cargo box, the adjustable bedslide assembly comprising:
a deck assembly; and
a frame assembly;
wherein the frame assembly is composed of a first frame section and a second frame section;
wherein the first frame section is configured to attach to the cargo box;
wherein the second frame section attaches to the deck assembly;
wherein the second frame section is engageable with and movable relative to the first frame section;
wherein the deck assembly is composed of a first deck portion and a second deck portion; and
wherein the first deck portion is engageable with the second deck portion so the deck assembly is adjustably sizable to fit within dimensions of the cargo box.

20. The adjustable bedslide assembly of claim 10, wherein the first deck portion includes a first index and the second deck portion includes a second index so that the first deck portion is positionable to any one of a plurality of positions with respect to the second deck portion so the deck assembly is adjustably sizable to any one of a plurality of predetermined sizes based on the first and second indexes.
